(19) United States
(12) Patent Application Publication
(10) Pub. No.: US 2016/0242879 A1
(43) Pub. Date: Aug. 25, 2016

(54) DISPOSABLE EDENTULOUS TRAY AND METHOD FOR PRODUCING COMPLETE DENTURE USING SAME

(71) Applicant: Su Bin LEE, Gyeonggi-do (KR)

(72) Inventor: Subin LEE, Goyang-si (KR)

(21) Appl. No.: 15/026,597

(22) PCT Filed: Apr. 30, 2014
(86) PCT No.: PCT/KR2014/003847

§ 371 Date: Mar. 31, 2016

(30) Foreign Application Priority Data
Oct. 14, 2013 (KR) 10-2013-0122037

(51) Int. Cl. A61C 9/00

(52) U.S. Cl. CPC A61C 9/0006

(57) ABSTRACT

The present invention relates to a disposable edentulous tray and a method for producing a denture using the same and, particularly, to a new form of a disposable edentulous tray and a method for producing a complete denture using the same, the disposable edentulous tray being capable of: simplifying the operating process of the complete denture for a patient in an edentulous state (the state of having no teeth) by using the disposable edentulous tray in a most similar form to the gum condition of the patient; acquiring an accurate impression; and resolving patient discomfort by simplifying manufacturing steps and thus reducing the number of patient hospital visit days

### TECHNICAL FIELD

The present invention relates to a disposable edentulous tray and a method for making complete dentures using the same, and in particular to a new type of disposable edentulous tray and a method for making complete dentures using the same wherein a fabricating procedure of complete dentures for a patient who has no teeth (a state where any of teeth is not present) can be simplified using a disposable edentulous tray which is most similar to an oral structure of the patient, and an accurate impression can be taken, and a fabricating procedure can be simplified, which is able to reduce the frequency of a patient's visit, thus improving a patient's inconvenience.

### BACKGROUND ART

The method for making a denture using a mesh type glass fiber (Korean patent registration number 10-1101564 and Registration date: Dec. 26, 2011) includes,

in the method for making a denture,

a step wherein an impression is taken from the inside of an oral cavity using an individual tray from an edentulous person, and a master cast is made, a step wherein an occlusion rim is fabricated using a wax on the master cast, and artificial teeth are arranged, thus making a wax denture, a step wherein the wax denture is placed in a flask and is first invested with plaster and is hardened, a step wherein a plaster separating medium is coated, on which the first invested plaster is hardened, and the plaster is second poured, and the upper and lower boxes of the flask are engaged and hardened, a step wherein when the second poured plaster is hardened, the flask is placed in boiling water, and the wax of the wax denture is melted, and the upper and lower boxes of the flask are separated,

a step wherein a hardened mesh type glass fiber frame is manufactured using the master cast,

a step wherein the glass fiber frame hardened after the resin is inputted into the upper and lower boxes of the flask is fixed at the top of the inputted resin,

a step wherein the upper and lower boxes of the flask are engaged and is polymerized by pressurizing the glass fiber and the resin, and a step wherein the denture is deflasked from the flask after the polymerization is completed and is trimmed and polished, thus finishing a final denture, and

the step for manufacturing a hardened glass fiber frame using the master cast includes:

a step wherein a wax sheet is attached after a wax separating medium is coated on the master cast,

a step wherein a plurality of holes are formed at the wax sheet, and a partial resin is filled in each hole,

a step wherein a mesh type glass fiber is disposed on the top of the wax sheet,

a step wherein the master cast wherein the glass fiber is disposed is inserted in a vacuum device and is compressed into a vacuum state,

a step wherein the master cast which has been compressed into the vacuum state is processed for the glass fiber to be hardened in a device which equips with a lamp, and a step wherein the maser cast wherein the glass fiber has been hardened is inputted in boiling water, and a wax sheet is melted, and the hardened glass fiber is separated from the master cast. The manufacturing thereof is carried out through the above-mentioned steps.

In a state where the above technology is directly employing the conventional method for making dentures, the holes are simply formed at the master cast, and the mesh type glass fiber is filled in each hole and is hardened. In this case, the above technology is not able to resolve the problems, for example, it is still hard to take an accurate impression which in general occurs in the conventional denture manufacturing technology, and it takes long to make the denture, and a patient should frequently visit the hospitals.

The conventional method for complete dentures fabrication using a prefabricated tray which is currently underway at the dental clinic will be described step by step below.

<1st Step>

The oral status of a patient is checked.

<2nd Step>

A proper sized stock tray which most matches with the patient's mouth is selected among assorted sizes and forms of trays.

<3rd Step>

The selected tray is modified using utility wax in order to accurately make an impression of the oral structures of the patient.

<4th Step>

An impression is prepared by loading an impression material in the inside of the tray.

<5th Step>

A preliminary impression is taken from the patient's mouth.

<6th Step>

The impressions of the upper and lower arches are taken using an impression material.

<7th Step>

A plaster is poured in the impression, thus fabricating a study cast of the patient.

<8th Step>

The study cast is drawn to the limit so as to extend the denture to the maximum range lest it is not influenced when surrounding muscles move in the inside of the patient's mouth.

<9th Step>

The study cast drawn up to the extension limit is checked.

<10th Step>

A baseplate wax is spread on the study cast, thus obtaining a space for the final impression material.

<11th Step>

An individual tray is fabricated over the wax spacer by using a resin powder and liquid mix, and the completed tray is delivered from a dental laboratory.

<12th Step>

The individual tray fabricated at the dental laboratory is tried in the patient's mouth, and a green molding compound is placed on an edge portion of the individual tray and is placed in the mouth, thus checking any movement of the surrounding muscles, and it is extended up to the extension limit of the denture.

<13th Step>

If the border extends up to the extension limit over multiple checks, the final impression material is loaded in the inside of the individual tray, and the final impression is taken.

<14th Step>

The dental stone is poured in the final impression, and the working cast is made, and the remaining denture making is carried out.

As described above, since the impression is taken using the conventional metal tray, it is impossible to take an accurate functional impression which well matches with the patient. In order to resolve the problems, a customized individual tray is separately fabricated using a result of the impression which was taken using the stock tray. For this procedure, it takes time to fabricate the individual tray, and for this reason, the patient must visit the dental clinic a couple of times for the sake of impression taking, which cause inconvenience to the patient.

For this reason, the conventional method has a problem since it takes a long time until the complete denture is made and delivered to the patient.

### DISCLOSURE OF INVENTION

Accordingly, the present invention is made in an effort to resolve the above problems. it is an object of the present invention to provide a new type disposable edentulous tray and a method for fabricating a complete denture using the same wherein the tray is made of a rigid synthetic resin, and an accurate impression of a patient can be fast taken in such a way to provide a disposable edentulous tray having an exterior which is similar to a gingiva pattern of a patient, and a pressure can be selectively applied during an impression taking so as to fabricate a complete denture by structurally forming a portion which is able to withstand a pressure during the impression taking, and an anatomically accurate impression can be taken by forming a handle at an outer portion where a slope and height don't interfere with the motions of muscles.

### TECHNICAL SOLUTION

To achieve the above objects,

According to one aspect of the present invention,

there is provided a disposable edentulous tray, which may include, but is not limited to, an upper tray and a lower tray which are inserted in an oral cavity to take an upper arch and a lower arch,

wherein the upper tray (10) may include an accommodation part (11) which is made of a synthetic resin material which can be partially cut off, if necessary, and is formed similar to an oral cavity of a human body and is formed in a bowl shape one side of which is open, and an impression material can be accommodated in the accommodation part; and a handle (13) is formed integral at a portion in such a way that the height and slope don't interfere when guiding the motions of the lip muscles, and an end portion thereof is protruding outward, and

the lower tray (20) may include an accommodation part (21) which is made of a synthetic resin material which can be partially cut off, if necessary, and is formed similar to the oral cavity of the human body and is formed in a horseshoe shape one side of which is open, and impression material is accommodated in the accommodation part, and a handle (23) which is formed integral at a portion wherein the height and slope don't interfere when guiding the motions of the lip muscles, wherein an end portion thereof is protruding outward.

A pressure part (12) is further provided in the accommodation parts (11, 21) of the upper tray (10) and the lower tray (20), wherein the pressure part indicates a portion to which a pressure is applied on a histological and anatomical basis.

A pressurization position part (14) is further provided on the outer surfaces of the upper tray (10) and the lower tray (20) in order to show a portion where the positioning of the upper tray (10) and the lower tray (20) can be easily carried out without any strain during the impression taking.

An adhesive for impression material is coated on the accommodation parts (11, 21) of the upper tray (10) and the lower tray (20), thus preventing a separation of the impression material from the tray.

Meanwhile, there is provided a method for complete dentures using a disposable edentulous tray, which may include, but is not limited to,

a tray selection and fine adjustment step (S1) wherein the tray most similar to an oral cavity of a patient is selected among the disposable edentulous trays, and the selected tray is inserted in the patient's mouth to confirm the proper size, and if an edge thereof is too long, the longer edge portion of the tray is directly cut off to make the tray to match with the oral cavity of the patent, thus adjusting the tray;

an impression taking step S2 wherein a thin and fine impression is taken by taking the impression in a state where a first impression material is injected in the accommodation parts of the upper tray and the lower tray which have been finally adjusted, and a second impression material is coated on the border of the tray; and

a master cast fabricating step S3 wherein the master cast is made using the impression same as the oral cavity of the patient.

### Advantageous Effects

According to the disposable edentulous tray and a method for fabricating a complete denture using the same, since it is possible to fabricate a customized individual tray at a time without using a conventional stock tray the fabricating procedure of which is complicated, wherein impressions should be taken a couple of times, the procedure until the final impression taking can be simplified, whereupon it is possible to provide a convenience to a patient thanks to the lowered fatigue and the reduced frequency of hospital visits which can be obtained due to the simplified fabrication procedures of the patient.

Since the fabricating procedure of the tray can be simplified, and the tray customized to the patient individual can be fast provided, denture insertion can be advanced, and it is possible to provide the best service to a patient who cannot masticate due to the edentulous state.

Moreover, any contamination between the patients can be prevented thanks to the use of a disposable tray, and it is possible to save a lot of costs, for example, the cost for the disinfection and maintenance of a tray, the cost due to multiple procedures, and the cost for fabricating the trays.

### BRIEF DESCRIPTION OF DRAWINGS

FIG. 1 is a photo showing a conventional stock tray.

FIGS. 2 and 3 are photos showing the exteriors of an upper disposable edentulous tray according to the present invention.

FIGS. 4 and 5 are photos showing the exteriors of a lower disposable edentulous tray according to the present invention.

FIG. 6 is a block diagram for describing a fabricating method of a complete denture using a disposable edentulous tray according to the present invention.

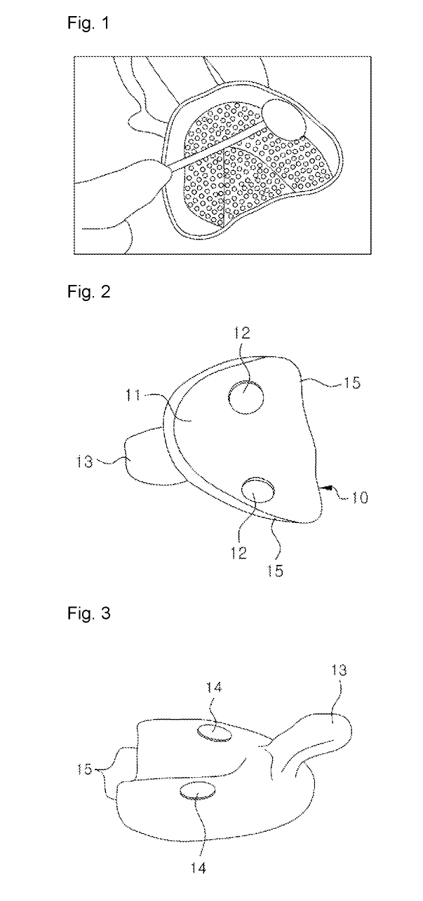

### BEST MODES FOR CARRYING OUT THE INVENTION

The preferred embodiments of the present invention will be described in detail with reference to the accompanying drawings to the extent that a person having ordinary skill in the art can easily carry out. The present invention may be implemented in various different forms and it is not limited to the embodiments below.

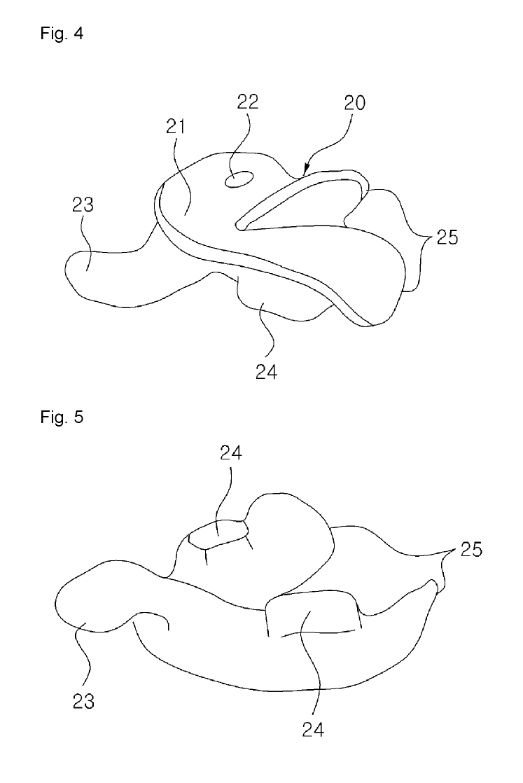

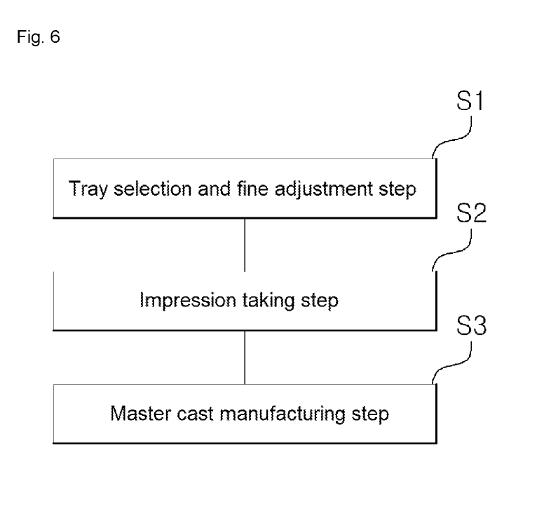

FIGS. 2 and 3 are photos showing the exteriors of an upper disposable edentulous tray according to the present invention, and FIGS. 4 and 5 are photos showing the exteriors of a lower disposable edentulous tray according to the present invention.

As illustrated in the drawings, the disposable edentulous tray according to the present invention an upper tray 10 to fabricate upper denture of a patient, and a lower tray 20 to fabricate lower denture of the patient.

Moreover, the upper tray 10 and the lower tray 20 have the exteriors which are similar to the custom tray fabricate using a synthetic resin material so as to adjust the size thereof.

The upper tray and the lower tray 20 are made of a rigid synthetic resin and have the exteriors similar to the patient's oral cavity, thus minimizing any irritation feeling when taking the impression. In particular, a partial cutting and supplement of the tray is possible, and it is possible to take an accurate impression similar to the impression taken using the conventional custom tray.

It is preferred that the upper tray 10 and the lower tray 20 are manufactured into four kinds of different sizes so as to accommodate various kinds of oral cavity sizes of the patients. So, it is possible to take an accurate impression using a tray most similar to the oral cavity configuration of the patient which is made in the forms of four kinds of average sizes.

The upper tray 10 may include an accommodation part 11 which is formed in a bowl shape one side of which is open, and in the inside of which an impression material is filled, a pressure part 12 which is formed at both sides of the accommodation part 11 and is configured to indicate a portion to which a pressure may be anatomically applied, a handle 13 which is protruding outward in such a way that the height and slope don't interfere when guiding the movement of the lip muscles, and a pressure part 14 which is showing a position to which the hold of the upper tray 10 is available during the impression taking. The above components are formed integral thereat.

The lower tray 20 may include an accommodation part 21 formed in a U-shape and in the inside of which an impression material is accommodated, a pressure part 22 which is formed at both sides and indicates a portion even though a pressure is applied on a histological and anatomical basis, a handle 23 which is protruding outward in such a way the height and slope don't interfere when guiding the movement of the lip muscles, and a pressurization position part 24 which is provided at an outer side and shows a portion to which the lower tray 20 can be applied during the impression taking. The above components are formed integral thereat.

Moreover, if the edge portions 15 and 25 are longer after the upper tray 10 and the lower tray 20 are matched with the oral cavity structure of the patient, the longer portions can easily cut off since they are made of synthetic resins, and if they are shorter, a high viscosity type impression material may be added to an edge, thus extending the same. In this way, it is possible to take an impression up to the limit to which the denture can extend by one time impression.

Moreover, the trays 10 and 20 are made disposable, thus preventing any contamination between the patients, and the disinfection and maintenance of the tray are easy, and it does not need to ask the dental laboratory to fabricate the tray, thus saving the fabricating cost.

### MODES FOR CARRYING OUT THE INVENTION

The method for fabricating the complete denture using a disposable edentulous tray according to the present invention will be described in detail step by step.

<Tray Selection and Fine Adjustment Step>

The disposable edentulous tray most similar to the patient's oral cavity structure is selected among four disposable trays, and the selected disposable tray is tried in the patient's mouth, and if the edge is too long, the longer edge portion is directly cut off, thus adjusting the disposable tray to the oral cavity structure of the patient.

The thusly adjusted tray is disposable and optimized to the patient's oral cavity structure. So, it can be discarded after use, so the sanitary maintenance of the tray can be easily obtained.

<Impression Taking Step>

A high viscosity impression material is loaded in the accommodation parts 11 and 21 of the disposable upper tray 10 and the disposable lower tray 20 which have been adjusted, thus first taking the impression of the whole oral cavity. The disposable tray is converted into an individual tray which can be well matched to the patient.

An adhesive for impression material is coated on the accommodation parts 11 and 21 of the upper tray 10 and the lower tray 20, thus preventing the separation of the impression material from the tray.

In a state where the disposable tray is converted into an individual tray same as the patient's oral cavity structure, a low viscosity impression material is coated on the accommodation parts 11 and 21, thus carrying out the second impression taking, whereby a thin and fine impression is taken and finished.

As another example of the final impression taking, in a state where a higher viscosity impression material may be loaded into the accommodation parts of the finely adjusted upper tray and lower tray, and a lower viscosity impression material may be coated on the high viscosity impression material surface, the impression taking is carried out again, thus taking a thin and fine impression.

Moreover, as further another example of the final impression taking, a higher viscosity impression material may be coated on the edge of the finely adjusted tray and a lower viscosity impression material may be loaded on the inner side of the tray. In this way, it is possible to take the impression up to the limit with the aid of the higher viscosity impression material, and since the lower viscosity impression material is coated on all the surfaces, the fine impression taking can be carried out with respect to all the portions.

<Fabricating Step of Master Cast>

A master cast is made from impression in the same structure as the oral cavity type of the patient. The complete denture is finished using the master cast in a conventional way.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### INDUSTRIAL APPLICABILITY

The disposable edentulous tray according to the present invention allows the user to provide the best services to the patients in such a way that the conventional complete denture fabricating method formed of complicated steps can be simplified, and any fatigue of the patient is lessened thanks to the simple procedure, and the patient's convenience is enhanced by reducing the frequency of the visits to the dental clinic, and the tray optimized to each patient individual is fast provided, thus accelerating the denture insertion. The present invention is applicable since the disposable tray of the patient individual is used, thus preventing any contaminations between the patients, and the costs, for example, the cost for the disinfection and maintenance of the tray, the cost for the frequent visits to the dental clinic, and the cost for the custom tray can be greatly saved.

1. A disposable edentulous tray, comprising:
an upper tray and a lower tray which are inserted in an oral cavity to take the patterns of an upper gingiva and a lower gingiva, wherein the upper tray 10 comprises an accommodation part 11 which is made of a synthetic resin material which can be partially cut off, if necessary, and is formed similar to an oral cavity of a human body and is formed in a bowl shape one side of which is open, and an impression material can be accommodated in the accommodation part 11; and a handle 13 is formed integral at a portion in such a way that the height and slope don't interfere when guiding the movement of the lip muscles, and an end portion thereof is protruding outward, and the lower tray 20 comprises an accommodation part 21 which is made of a synthetic resin material which can be partially cut off, if necessary, and is formed similar to the oral cavity of the human body and is formed in a horseshoe shape one side of which is open, and impression material is accommodated in the accommodation part 21, and a handle 23 which is formed integral at a portion wherein the height and slope don't interfere when guiding the movement of the lip muscles, wherein an end portion thereof is protruding outward.

2. The tray of claim 1, wherein a pressure part 12 is further provided in the accommodation parts 11 and 21 of the upper tray 10 and the lower tray 20, wherein the pressure part 12 indicates a portion to which a pressure is applied on a histological and anatomical basis.

3. The tray of claim 1, wherein a pressurization position part 14 is further provided on the outer surfaces of the upper tray 10 and the lower tray 20 in order to show a portion where the holding of the upper tray 10 and the lower tray 20 can be easily carried out without any strain during the impression taking.

4. The tray of claim 1, wherein an adhesive for impression material is coated on the accommodation parts 11 and 21 of the upper tray 10 and the lower tray 20, thus preventing a separation of the impression material from the tray.

5. A method for fabricating a complete denture using a disposable edentulous tray, comprising:
a tray selection and fine adjustment step S1 wherein the tray most similar size to an oral cavity of a patient is selected among the disposable trays manufactured using the components of claim 1, and the selected tray is inserted in the patient's mouth to confirm the match with the oral cavity, and if an edge thereof is too long, the longer edge portion of the tray is directly cut off to make the tray to match with the oral cavity type of the patient, thus adjusting the tray;
an impression taking step S2 wherein a thin and fine impression is taken by taking the impression in a state where a first impression material is loaded in the accommodation parts of the upper tray and the lower tray which have been finally adjusted, and a second impression material is coated on the surface of the first impression; and
a master cast manufacturing step S3 wherein the master cast is made from the impression same as the oral cavity type of the patient.
